(19) United States
(12) Patent Application Publication
(10) Pub. No.: US 2011/0295989 A1
(43) Pub. Date: Dec. 1, 2011

(54) NETWORK SYSTEM, NETWORK MANAGEMENT DEVICE AND GATEWAY DEVICE

(75) Inventor: SATOSHI KIYOTO, Fujisawa (JP)

(73) Assignee: Hitachi, Ltd.

(21) Appl. No.: 13/025,850

(22) Filed: Feb. 11, 2011

(30) Foreign Application Priority Data
Jun. 1, 2010 (JP) 2010-125558

(51) Int. Cl. G06F 15/173

(52) U.S. Cl. 709/223

(57) ABSTRACT

It provides a network management system in which the expandability of a network management device is increased, and the cost for expanding the function is suppressed. A gateway is provided between an SNMP network and the internet, making it possible to operate an MIB using an HTTP and receive a Trap. The network management device is provided as a Web service for a Web browser, making it possible to cooperate with the other various Web services and easily expand the function by adding the Web service to the network management device.

### CLAIM OF PRIORITY

The present application claims priority from Japanese patent application JP 2010-125558 filed on Jun. 1, 2010, the contents of which are hereby incorporated by reference into this application.

### BACKGROUND OF THE INVENTION

1. Field of the Invention

The present invention relates to a network system, a network management device and a gateway device, and more particularly to a network system using an SNMP-Web gateway in the Web technology, and a network management device and a gateway device for use in the network system.

2. Description of the Related Art

A current network management technology depends on an Simple Network Management Protocol (SNMP).

FIG. 2 shows an example of a network management system using the general SNMP. A plurality of SNMP agents 114 and 115 are connected on an SNMP network 109, and an SNMP manager 201 collectively manages them.

In patent document JP-A-9-73423, it is disclosed that if a Common Management Information Protocol (SNMP-CMIP) gateway 110 is installed, the SNMP manager 201 could also manage CMIP agents 112 and 113 connected to a CMIP network 111.

A general internal configuration of the SNMP manager 201 is made up of a TCP/IP processing part 188 for processing a TCP/IP protocol, an SNMP processing part 187 for processing an SNMP protocol, a Management Information Base (MIB) Data Base (DB) 189, and an MIB compiler 190 for adding the MIB for new management, as the base, and a management application group 202 including a plurality of applications 203 to 206 for management on that base.

Also, on the other hand, every time a new protocol or new network device is produced, the MIB on the protocol or MIB intrinsic to the network device is created, so that an enormous amount of MIB is defined at present.

Herein, the MIB is abstraction of the statistical information (send or receive packet number and so on) or management information (sort of device, name, configuration, administrator, installation place and so on) held by the SNMP agent, and can be uniquely identified by an Object IDentifier (OID).

In patent document JP-A-2008-269092, it is disclosed that any network device not supporting the SNMP could be also managed in the SNMP by using an SNMP mediator.

### SUMMARY OF THE INVENTION

While an enormous amount of MIB or SNMP agent comes into existence, the technology for expandability of the SNMP manager, namely, easily adding the application group has made little advancement. Therefore, there are two options of using the expensive and perfunctory SNMP manager and using the SNMP manager of its own provided by a network device vendor.

If the expensive and perfunctory SNMP manager is used, the usage is almost fixed, whereby there is a problem that the cost of making the original expansion to suit the network for management is too much.

Also, if the SNMP manager of its own provided by the network device vendor is used, it is required that the SNMP manager is properly used for each network device in the network in the multi-vendor environments, whereby there is a problem that the management becomes complicated.

A primary cause of poor expandability may be that the SNMP protocol involves sending or receiving the messages binary encoded by an encoding method of an Abstract Syntax Notation One (ASN.1) Basic Encoding Rules (BER), which is less expandable than a data sending or receiving method in a text form of an eXtensible Markup Language (XML) base by the Web technology in the mainstream at present.

In patent document JP-A-2002-101098, it is disclosed that an application group is created as a CORBA module, using a Common Object Request Broker Architecture (CORBA) technique, and the communication is made via a CORBA-SNMP gateway to improve the expandability and reusability of the application group, though the cost of creating the CORBA module itself occurred to make the expansion. Also, in a wide area network environment, there is a problem that the CORBA communication cannot be made through a FireWall (FW).

In the light of the above-mentioned problems, an object of the invention is to provide a network system, a network management device and a gateway device in which the expandability of the network management device is increased, and the cost for expanding the function is suppressed.

In order to accomplish the above object, an application example 1 of the invention is a gateway device having an HTTP processing part for receiving a HyperText Transfer Protocol (HTTP) request message and sending an HTTP response message, and an SNMP processing part for sending an SNMP request message and receiving an SNMP response message, wherein the gateway device includes an SNMP request processing part for creating the SNMP request message from the HTTP request message received by the HTTP processing part and passing it to the SNMP processing part, and an HTTP response processing part for creating the HTTP response message from the SNMP response message received by the SNMP processing part and passing it to the HTTP processing part.

Also, an application example 2 of the invention is a gateway device having an SNMP processing part for receiving an SNMP Trap message, wherein the gateway device includes an SNMP Trap processing part for inputting the received SNMP Trap message into an SNMP Trap queue.

Also, an application example 3 of the invention is a gateway device having an HTTP processing part for receiving an HTTP request message of requesting an SNMP Trap message, wherein the gateway device includes an SNMP Trap processing part for taking out the SNMP Trap message, creating an HTTP response message including the contents of the SNMP Trap message, and passing it to the HTTP processing part, if the SNMP Trap message is inputted in the SNMP Trap queue.

Also, an application example 4 of the invention is a gateway device having an HTTP processing part for receiving an HTTP request message of requesting an SNMP Trap message, wherein the gateway device includes an SNMP Trap processing part for waiting for the SNMP Trap message to be inputted for a certain long period of time, if the SNMP Trap message is not inputted in the SNMP Trap queue, in which if the SNMP Trap message is inputted, the SNMP Trap processing part takes out the SNMP Trap message, creates an HTTP response message including the contents of the SNMP Trap message, and passes it to the HTTP processing part, while if the SNMP Trap message is not inputted, the SNMP Trap processing part creates an HTTP response message indicating that there is no SNMP Trap message, and passes it to the HTTP processing part.

Since the gateway device enables the operation of the MIB in the SNMP agent and the acquisition of the SNMP Trap message to be performed on the HTTP, it is possible to transparently manage the SNMP agents distributed over the internet partitioned by the FW (common effect to the application examples 1 to 4).

Also, an application example 5 of the invention is a network management device having an HTTP processing part for sending an HTTP request message to the gateway device and receiving a corresponding HTTP response message, wherein the network management device includes an OID table for holding the Object name of the MIB and the OID associated therewith, and an MIB operation part for searching the OID table, acquiring the corresponding OID from the Object name of the MIB, adding it as the parameter to the HTTP request, and passing it to the HTTP processing part.

Also, an application example 6 of the invention is a network management device having a statistical information table for holding the statistical information including the send Byte number, receive Byte number, send IP packet number, and receive IP packet number of each SNMP agent at each time, and including a statistical information processing part for periodically acquiring the statistical information of the SNMP agent via the MIB operation part and the gateway device, and updating the statistical information table.

Also, an application example 7 of the invention is a network management device having an HTTP processing part for sending an HTTP request message to the gateway device and receiving a corresponding HTTP response message from the gateway device, wherein the network management device has a Trap table for holding the contents of the SNMP Trap message, and includes a Trap processing part for creating the HTTP request message of requesting the SNMP Trap message, receiving the HTTP response message via the HTTP processing part, and updating the Trap table if the contents of the SNMP Trap message are included.

Also, an application example 8 of the invention is a network management device having an HTTP processing part for receiving an HTTP request message from the Web browser and sending a corresponding HTTP response message, wherein the network management device includes a network information processing part for receiving the HTTP request message of requesting the MIB of the SNMP agent from the Web browser via the HTTP processing part, acquiring the MIB via the MIB operation part and the gateway device, creating the HTTP response message including the MIB, and responding to the Web browser via the HTTP processing part.

Also, an application example 9 of the invention is a network management device having an HTTP processing part for receiving an HTTP request message from the Web browser and sending a corresponding HTTP response message, wherein the network management device includes a network information processing part for receiving the HTTP request message of requesting the statistical information of the SNMP agent from the Web browser via the HTTP processing part, acquiring the statistical information of the SNMP agent from the statistical information table, creating the HTTP response message including the statistical information, and responding to the Web browser via the HTTP processing part.

Also, an application example 10 of the invention is a network management device having an HTTP processing part for receiving an HTTP request message from the Web browser and sending a corresponding HTTP response message, wherein the network management device includes a network information processing part for receiving the HTTP request message of requesting the Trap information from the Web browser via the HTTP processing part, acquiring the Trap information from the Trap table, creating the HTTP response message including the Trap information, and responding to the Web browser via the HTTP processing part.

Also, the network management device makes it possible to provide the operation of acquiring the MIB, acquiring the statistical information, or acquiring the Trap information as a Web service (common effect to the application examples 5 to 10).

Also, an application example 11 of the invention is a network management device including a Web service processing part for receiving an HTTP request message of requesting the use of a Web service on the internet from the Web browser via the HTTP processing part, taking out an input parameter of the Web service from the received HTTP request message, making access to the Web service via the HTTP processing part, creating an HTTP response including the result, and responding to the Web browser via the HTTP processing part.

Also, an application example 12 of the invention is a network management device including a Web service processing part corresponding to each of a plurality of Web services on the internet.

Also, the network management device enables the Web service of network management to easily cooperate with the other various Web services (common effect to the application examples 11 and 12).

Also, an application example 13 of the invention is a network management system composed of the Web browser, the gateway device and the network management device, in which the network management system can acquire the MIB or statistical information or Trap information via the network management device and the gateway device, make access to the Web service via the network management device based on the acquired information, and display the result integrated with the MIB on the Web browser.

Also, since the network management system enables the Web service to be simply added, it is possible to construct the network management system with excellent expandability at a lower cost (effect corresponding to application example 13).

According to the first solving means of this invention, there is provided a network system comprising:

a gateway device for creating an SNMP request message from a first HTTP request message and sending it to an SNMP agent, and creating and sending a first HTTP response message from an SNMP response message to the SNMP request message; and

a network management device for communicating with the gateway device;

wherein the network management device includes:

an HTTP processing part for sending and receiving an HTTP request message and an HTTP response message corresponding thereto;

a network information processing part for receiving a second HTTP request message for requesting a desired Management Information Base (MIB) of the SNMP agent via the HTTP processing part from a Web browser; and

an MIB operation part for creating the first HTTP request message including an object identifier of the desired MIB and outputting it via the HTTP processing part to the gateway device;

wherein the network information processing part receives the first HTTP response message to the first HTTP request message from the gateway device, the first HTTP response message including the MIB of the SNMP agent, creates a second HTTP response message including the MIB and sends it via the HTTP processing part to the Web browser.

According to the second solving means of this invention, there is provided a network system comprising:

a gateway device for storing a received SNMP Trap message; and

a network management device for communicating with the gateway device;

wherein the network management device includes:

an HTTP processing part for sending and receiving an HTTP request message and an HTTP response message corresponding thereto;

a Trap table for holding contents of the SNMP Trap message received from the gateway device;

a Trap processing part for creating a first HTTP request message for requesting the SNMP Trap message, sending it via the HTTP processing part to the gateway device, receiving a first HTTP response message including the contents of the SNMP Trap message from the gateway device via the HTTP processing part, and storing the contents of the SNMP Trap message in the Trap table; and

a network information processing part for receiving a second HTTP request message for requesting Trap information from the Web browser via the HTTP processing part, acquiring the contents of the SNMP Trap message from the Trap table, creating a second HTTP response message including the contents of the SNMP Trap message, and sending it via the HTTP processing part to the Web browser.

According to the third solving means of this invention, there is provided a network management device in a network system which comprises a gateway device for creating an SNMP request message from a first HTTP request message and sending it to an SNMP agent, and creating and sending a first HTTP response message from an SNMP response message to the SNMP request message and, the network management device for communicating with the gateway device, the network management device comprising:

an HTTP processing part for sending and receiving an HTTP request message and an HTTP response message corresponding thereto;

a network information processing part for receiving a second HTTP request message for requesting a desired Management Information Base (MIB) of the SNMP agent via the HTTP processing part from a Web browser; and

an MIB operation part for creating the first HTTP request message including an object identifier of the desired BIB and outputting it via the HTTP processing part to the gateway device;

wherein the network information processing part receives the first HTTP response message to the first HTTP request message from the gateway device, the first HTTP response message including the MIB of the SNMP agent, creates a second HTTP response message including the BIB and sends it via the HTTP processing part to the Web browser.

According to the fourth solving means of this invention, there is provided a gateway device comprising:

an HTTP processing part for receiving an HTTP request message from a network management device and sending an HTTP response message to the network management device;

an SNMP processing part for sending an SNMP request message to an SNMP agent and receiving an SNMP response message from the SNMP agent;

a request processing part for creating the SNMP request message from the HTTP request message received by the HTTP processing part and outputting it to the SNMP processing part; and

a response processing part for creating the HTTP response message from the SNMP response message received by the SNMP processing part and outputting it to the HTTP processing part,

wherein the request processing part creates the SNMP request message by adding request type information included in received HTTP request message and an object identifier for specifying information of object to the SNMP request message, and

wherein the response processing part creates the HTTP response message including the object identifier and value information, based on a pair of the object identifier and the value information indicating the information of the object that are included in the SNMP response message sent in response to the SNMP request message.

According to the invention, it is possible to provide a network system, a network management device and a gateway device in which the expandability of the network management device is increased, and the cost for expanding the function is suppressed.

### BRIEF DESCRIPTION OF THE DRAWINGS

FIG. 1 is a block diagram of an SNMP-Web gateway according to an embodiment of the invention.

FIG. 2 is a block diagram of an SNMP manager in the related art.

FIG. 3 shows a request message sequence.

FIG. 4 shows an example of an HTTP request message (Get Request).

FIG. 5 shows an example of an HTTP request message (Set Request).

FIG. 6 is an organization view of an SNMP request message.

FIG. 7 is a flowchart showing the operation of an SNMP request processing part.

FIG. 8 is an organization view of an SNMP response message.

FIG. 9 shows an example of an HTTP response message.

FIG. 10 is a flowchart showing the operation of an HTTP response processing part.

FIG. 11 shows a Trap message sequence 1.

FIG. 12 shows a Trap message sequence 2.

FIG. 13 shows an example of an HTTP request message (Trap).

FIG. 14 is an organization view of an SNMP Trap message.

FIG. 15 shows an example of an HTTP response message (Trap).

FIG. 16 is a flowchart 1 showing the operation of an SNMP Trap processing part.

FIG. 17 is a flowchart 2 showing the operation of the SNMP Trap processing part.

FIG. 18 is a block diagram of a Web network management device according to one embodiment of the invention.

FIG. 19 is a table organization view of an OID table.

FIG. 20 is a flowchart 1 showing the operation of an MIB operation part.

FIG. 21 is a flowchart 2 showing the operation of the MIB operation part.

FIG. 22 is a table organization view of a statistical information table.

FIG. 23 is a flowchart showing the operation of a statistical information processing part.

FIG. 24 is a table organization view of a Trap table.

FIG. 25 is a flowchart showing the operation of a Trap processing part.

FIG. 26 is a flowchart showing the operation of a network information processing part.

FIG. 27 is a flowchart showing the operation of a Web service processing part.

FIG. 28 shows a message sequence in a network management system using this device.

FIG. 29 shows a display example of a Web browser.

FIG. 30 is an organization view of an MIB DB.

### DETAILED DESCRIPTION OF THE PREFERRED EMBODIMENTS

The embodiments of the present invention will be described below with reference to the drawings.

### First Embodiment

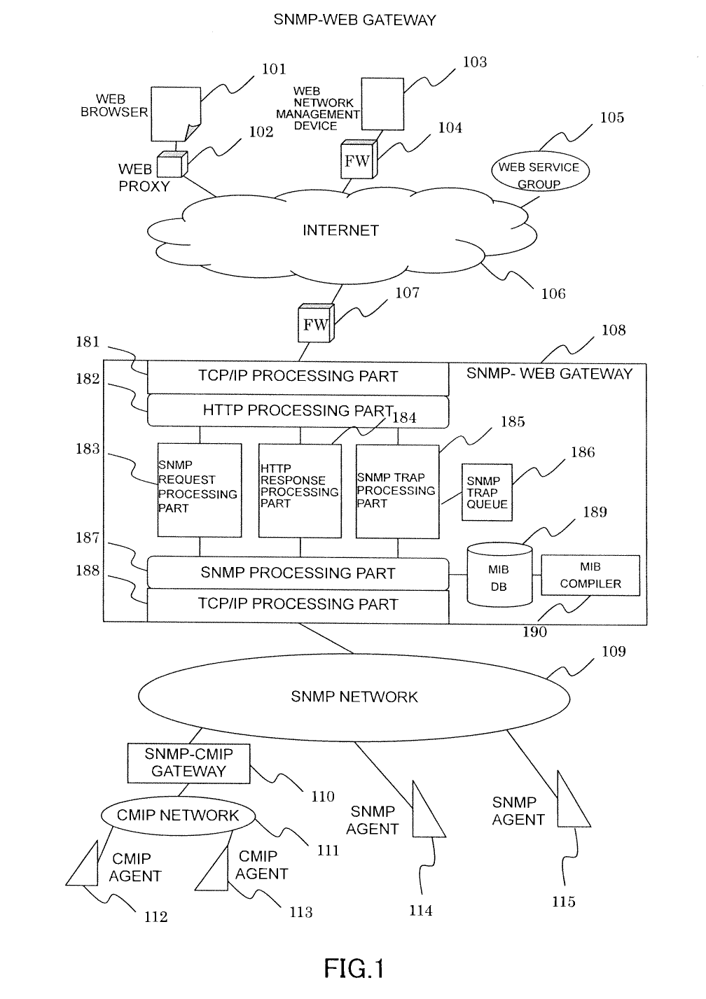

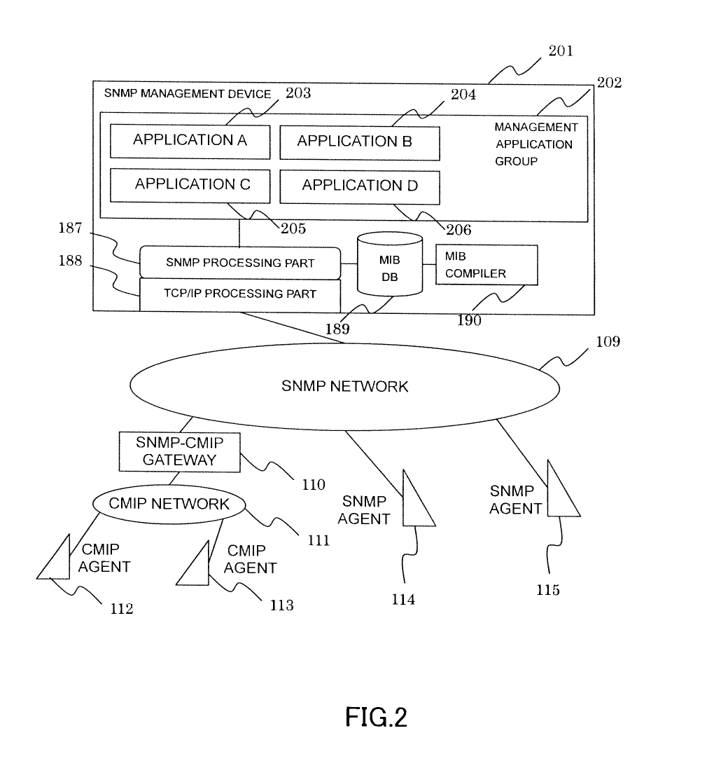

FIG. 1 is a block diagram of a gateway device 108 and a network system according to a first embodiment of the invention.

The gateway device (SNMP-Web gateway) 108 includes TCP/IP processing parts 181 and 188 for performing the processing of a TCP/IP protocol, an HTTP processing part 182 for performing the processing of an HTTP protocol, an SNMP processing part 187 for performing the processing of an SNMP protocol, an MIB DB 189 for holding an MIB for management, an MIB compiler 190 for adding a new MIB for management, an SNMP request processing part 183 for converting an HTTP request into an SNMP request, an HTTP response processing part 184 for converting an SNMP response into an HTTP response, an SNMP Trap queue 186 for accumulating an SNMP Trap message, and an SNMP Trap processing part 185 for accumulating the SNMP Trap message in the SNMP Trap queue 186 and making a response to an HTTP request message of requesting the SNMP Trap.

The gateway device 108 of this embodiment is connected to an SNMP network 109, with a plurality of SNMP agents (SNMP agent devices) 114 and 115 connected on the SNMP network 109. Also, an SNMP-CMIP gateway 110 is installed between a CMIP network 111 and the SNMP network, with the CMIP agents 112 and 113 connected on the CMIP network 111.

Also, the gateway device 108 of this embodiment is connected via a firewall (FW) 107 to an internet 106. A network management device (web network management device) 103 of this embodiment is connected via an FW 104 to the internet 106, and a Web browser 101 is connected via a web proxy 102 to the internet 106. Further, a various kinds of Web service group 105 is connected to the internet 106. The Web browser 101 may be realized by an appropriate device such as a server or terminal.

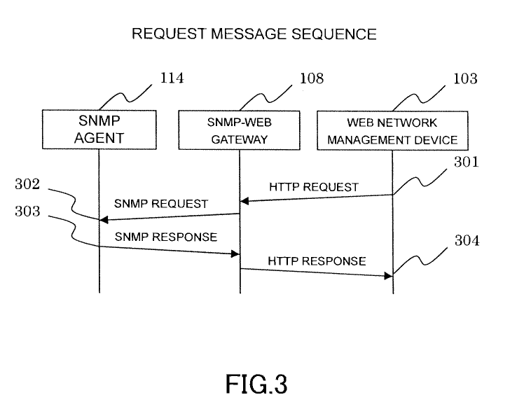

FIG. 3 is a chart showing a request and response message sequence between the gateway device 108, the network management device 103 and the SNMP agent 114 according to this embodiment.

An HTTP request message 301 issued from the network management device 103 is converted into an SNMP request message 302 in the gateway device 108, and sent to the SNMP agent 114. An SNMP response message 303 issued from the SNMP agent 114 is converted into an HTTP response message 304 in the gateway device 108, and sent to the network management device 103.

An HTTP request may be periodically sent from the network management device 108 to collect the statistical information, for example. Also, it may be sent from the network management device 108 to make an appropriate request or notification with the user's operation as a moment.

Practically, a plurality of FWs may exist between the gateway device 108 and the network management device 103, but they are omitted from the drawing, because the HTTP is transmittable. Also, the SNMP agent 114 can become a CMIP agent that exists ahead of the SNMP-CMIP gateway 110. The SNMP request message 302 may be sent to an appropriate agent device such as the CMIP agent 112, other than the SNMP agent 114, via an appropriate gateway such as the SNMP-CMIP gateway 110. In this embodiment, all of them are unified and explained as the SNMP agent.

First of all, the conversion from the HTTP request message to the SNMP request message will be described below.

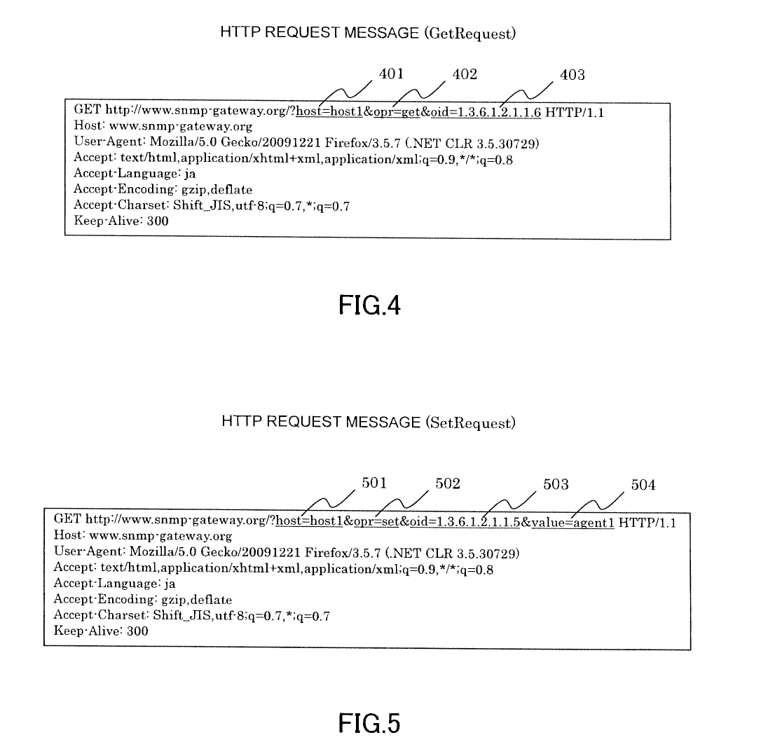

FIG. 4 is a view showing an example of the HTTP request message before conversion into a Get Request message of the SNMP.

Get Request is a message for acquiring the MIB of the agent. The parameter required for conversion is URL encoded and sent. In this drawing, a host 401 designates the host name of the SNMP agent at the sending destination. An opr 402 is a request type, indicating the Get Request message herein. An oid 403 designates the OID for identifying the MIB of object.

FIG. 5 is a view showing an example of the HTTP request message before conversion into a Set Request message of the SNMP.

Set Request is a message for setting the MIB of the agent. The parameter required for conversion is URL encoded and sent. In this drawing, a host 501 designates the host name of the SNMP agent at the sending destination. An opr 502 is a request type, indicating the Set Request message herein. An oid 503 designates the OID for identifying the MIB of object. A value 504 designates a setting value.

In conversion into the other SNMP request message, the necessary parameter is URL encoded and sent in the same way.

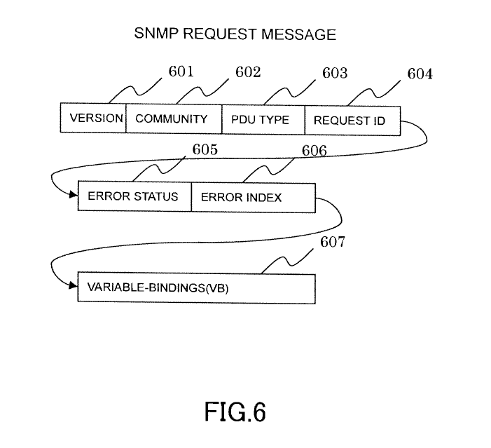

FIG. 6 is an organization view of the SNMP request message after conversion.

A Version 601 and a Community 602 are acquired and set from a predetermined setting file. A PDU type 603 is set in accordance with the assortment of the SNMP request message.

A request ID 604 is set to a value unique in the request message. An error status 605 and an error index 606 are unnecessary in the request message, and set to an adequate value (e.g., 0). A Variable Bindings (VB) 607 is set to a parameter value of URL encode in accordance with the assortment of the request message.

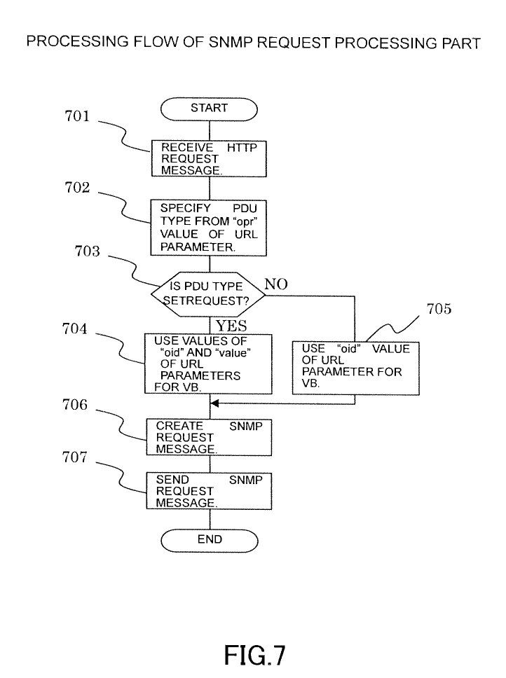

FIG. 7 is a flowchart showing the operation of the SNMP request processing part 183.

First of all, the SNMP request processing part 183 receives an HTTP request message from the network management device 103 (701), and specifies the PDU type 603 from the values of the parameters opr 402 and 502 of the URL encode (702). The SPUR request processing part 183 determines whether or not the PDU type 603 is Set Request (703). If YES, the SNMP request processing part sets the values of the parameters old 503 and value 504 of the URL encode in the VB 607 (704). On the other hand, if NO (in the case of Get Request), the SNMP request processing part 183 sets the value of the parameter oid 403 of the URL encode in the VB 607. Then, the SNMP request processing part 183 creates an SNMP request message (706). The values set at the above steps 702, 704 and 705 are used for the PDU type 602 and the VB 607 of the SNMP request message. The other fields are appropriately set as described above in FIG. 6. The SNMP request processing part 183 sends the created SNMP request message to the SNMP agent 114 (707). Though the process for the PDU type of Set Request and Get Request is only shown herein, the necessary parameter may be acquired from the URL encode and set to the VB in the case of the other types.

Next, the conversion from the SNMP response message to the HTTP response message will be described below.

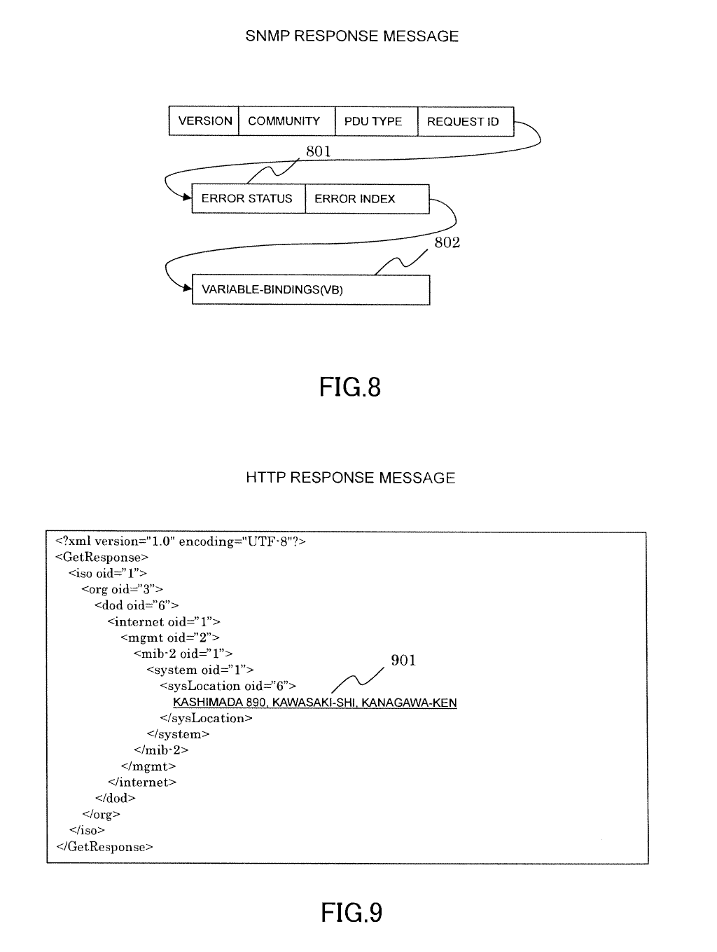

FIG. 8 is an organization view of the SNMP response message.

Though the organization is the same as in FIG. 6, whether there is an error or not is determined by referring to an error status 801. In the case of the response to the request of the type of acquiring the MIB, the acquired MID data is set in a VB 802. For example, a pair of oid and value is set. Two or more pairs may exist.

FIG. 9 is a view showing an example of the HTTP response message to Get Request.

The message is an XML base, and has an XML tree structure corresponding to an MIB tree structure. An Object name of each MIB is an element name of the XML, and oid is set as an attribute of each element. The acquired value of MIB is set as an element value 901.

In the example of the drawing, information of sys Location MIB is acquired, and as a result, the address of the device is returned.

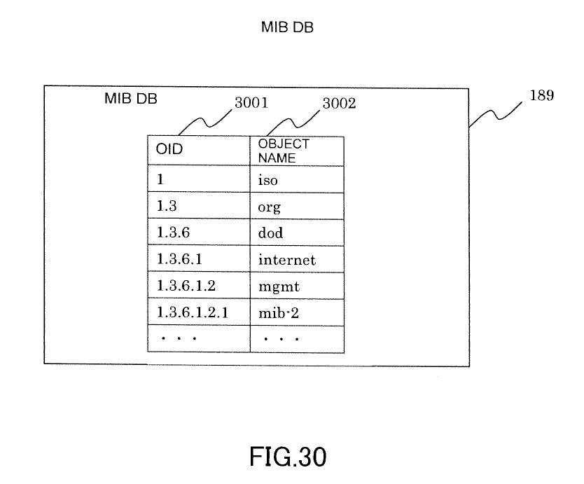

FIG. 30 is an organization view of an MIB DB.

The MIB DB 189 is composed of a pair of an OID 3001 and an Object name 3002, in which the Object name 3002 can be retrieved from the OID 3001. It is supposed that each MIB held by the SNMP agent of management object is registered in the MIB DB 189.

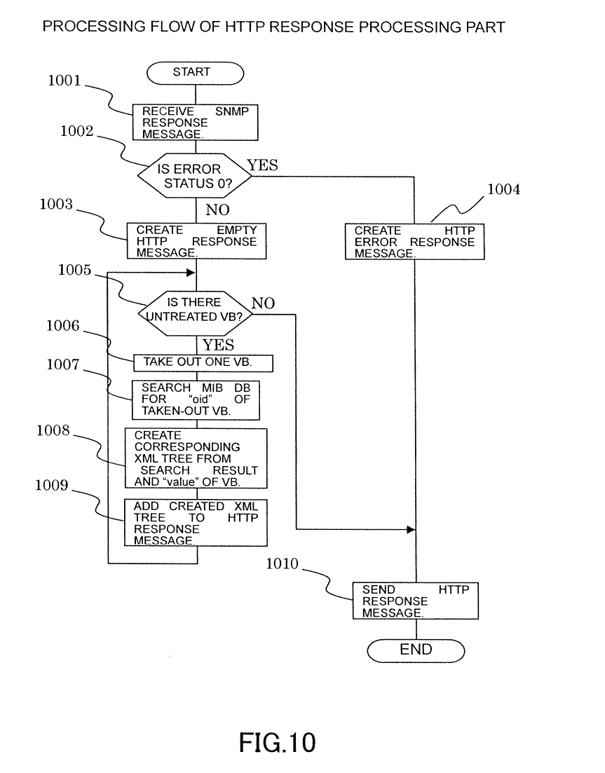

FIG. 10 is a flowchart showing the operation of the HTTP response processing part 184.

First of all, the HTTP response processing part 184 receives an SNMP response message (1001), and determines whether or not the error status 801 is 0 (value indicating an error) (1002). If YES, the HTTP response processing part creates an HTTP response message indicating the error (1004), and sends it (1010). On the other hand, if NO, the HTTP response processing part 184 firstly creates an empty HTTP response message (1003). And the HTTP response processing part 184 determines whether or not there is untreated VB within the VB 802 of the received SNMP response message (1005). If NO (there is no untreated VB), the HTTP response message is directly sent (1010). If YES, the HTTP response processing part 184 takes out one VB 802 (1006), and searches the MID DB 189 for the taken-out oid (1007). The object name (Object name) of the MIB is obtained as a search result, and the HTTP response processing part 184 creates a corresponding XML tree from the search result and the value of the VB 802 (1008). The HTTP response processing part 184 adds the created XML tree to the HTTP response message (1009). The above cycle is repeated until there is no untreated VB, and finally the HTTP response message is sent, for example, to the network management device 103 (1010).

Next, a process for an SNMP Trap message will be described below.

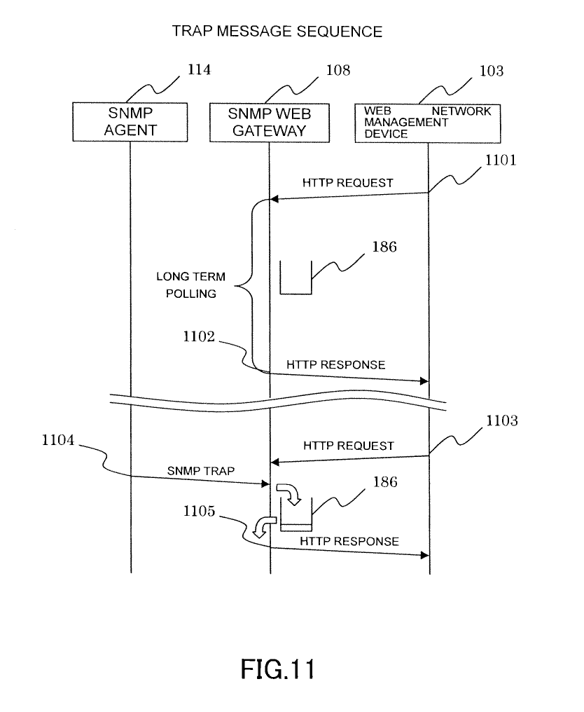

FIG. 11 is a chart showing a first message sequence of the Trap message.

The network management device 103 of this embodiment sends an HTTP request message of requesting the Trap information (1101). The gateway device 108 of this embodiment having received the HTTP request message monitors the SNMP Trap message to be accumulated in the SNMP Trap queue 186 for a relatively long, certain period of time such as five minutes from receiving. If the time out finally occurs, the gateway device 108 responds with an HTTP response message indicating no Trap (1102).

The gateway device 108 receives an HTTP request message (1103), and an SNMP Trap message from the SNMP agent 114 is accumulated in the SNMP Trap queue 186 (1104). Then, the gateway device 108 takes out the SNMP Trap message, stores it in an HTTP response, and sends the HTTP response to the network management device 103 (1105).

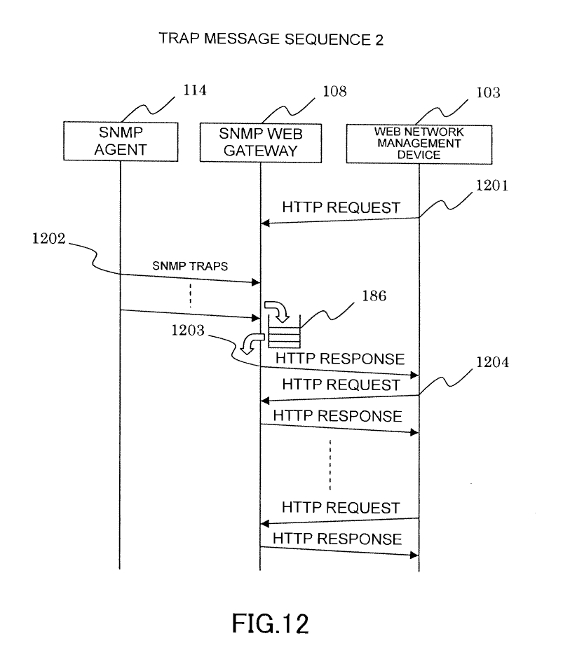

FIG. 12 is a chart showing a second message sequence of the Trap message.

The gateway device 108 of this embodiment receives an HTTP request message 1201, and receives a large number (plurality) of SNMP Trap messages from the SNMP agent 114 (1202) that are accumulated in the SNMP Trap queue 186. The gateway device 108 takes out the SNMP Trap messages one by one, stores each SNMP Trap message in the HTTP response and responds to the network management device 103 (1203). The network management device 103 receiving the HTTP response sends the HTTP request message at once (1204). The above cycle is repeated until the SNMP Trap queue 186 becomes empty.

FIG. 13 is a view showing an example of the HTTP request message in requesting the Trap information.

When the Trap information is requested, the URL of request may be changed to the URL dedicated to Trap (1301).

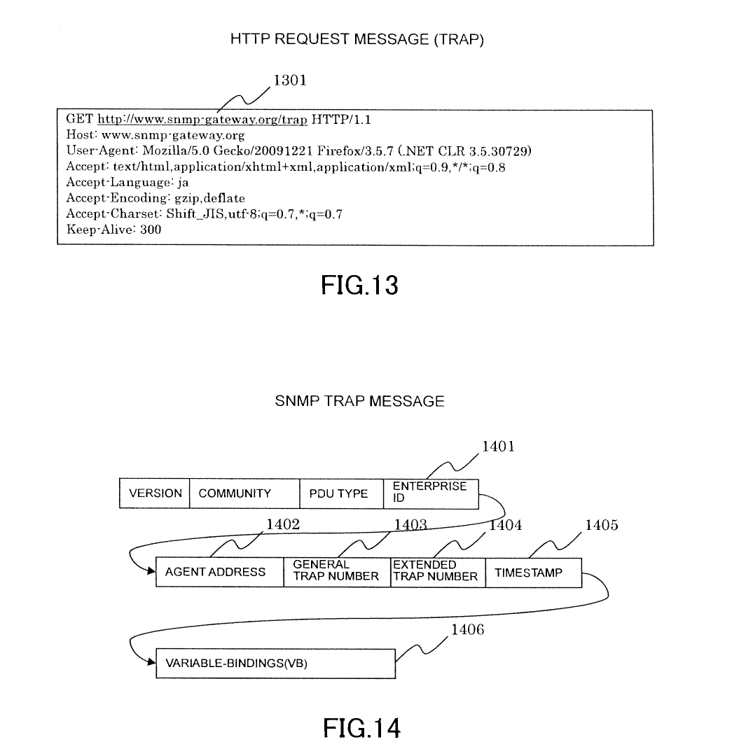

FIG. 14 is a message organization view of an SNMP Trap message.

The SNMP Trap message includes a PDU type, an enterprise ID 1401, an agent address 1402, a general Trap number 1403, an extended Trap number 1404, and a Time Stamp 1405, and thereafter a VB 1406, if necessary.

The enterprise ID 1401 is the ID for identifying the trap. For example, it designates an enterprise of the agent vendor. The agent address 1402 designates the address of an SNMP agent of the sender. The general Trap number 1403 is a predetermined number. The extended Trap number 1404 is the number unique to the vendor. The Time Stamp 1405 designates the occurrence time of Trap.

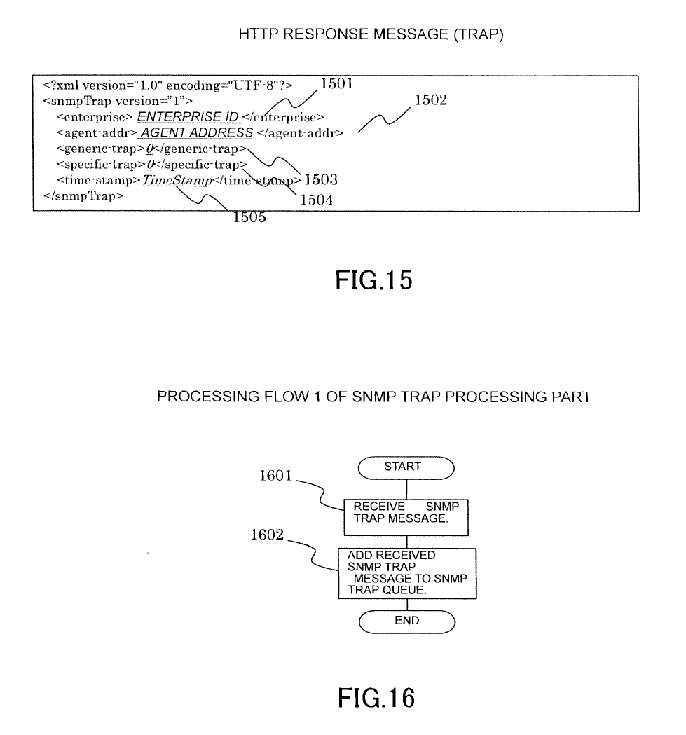

FIG. 15 is a view showing an example of an HTTP response message including the Trap information.

The HTTP response message includes an enterprise ID 1501, an agent address 1502, a general Trap number 1503, an extended Trap number 1504, and a Time Stamp 1505 as the element values of each XML.

Though an SNMP Pv1 Trap is described in this example, the same configuration may be taken for the Trap message in the other versions.

FIG. 16 is a flowchart 1 showing a first operation of the SNMP Trap processing part 185.

First of all, the SNMP Trap processing part 185 receives an SNMP Trap message (1601), and adds it to the SNMP Trap queue 186 (1602).

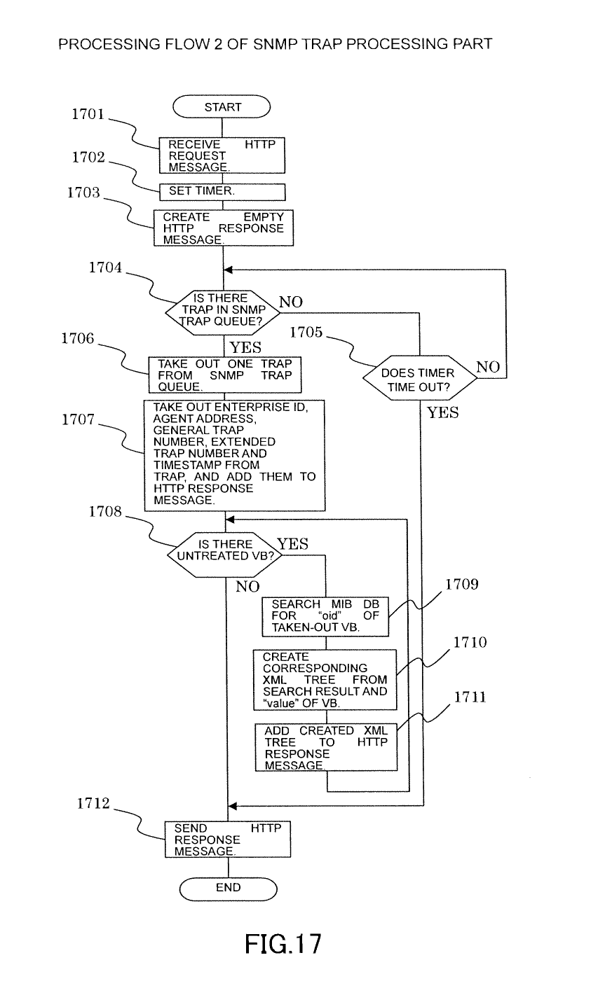

FIG. 17 is a flowchart 2 showing a second operation of the SNMP Trap processing part 185.

First of all, the SNMP Trap processing part 185 receives an HTTP request message (1701), and sets a timer (e.g., to 5 minutes) (1702). Then, the SNMP Trap processing part 185 creates an empty HTTP response message (1703). The SNMP Trap processing part 185 determines whether or not there is Trap in the SNMP Trap queue (1704). If NO, a determination is made whether the timer times out (1705). If the timer does not yet time out, the operation returns to the determination 1704 for the SNMP Trap queue again. On the other hand, if the timer times out (1705), an empty response message is sent (1712).

If there is Trap in the SNMP Trap queue at step 1704, the SNMP Trap processing part 185 takes out one Trap from the SNMP Trap queue (1706). And the SNMP Trap processing part 185 takes out the enterprise ID 1401, the agent address 1402, the general Trap number 1403, the extended Trap number 1404, and the Time Stamp 1405 from the Trap, and adds them to the HTTP response message created at step 1703. The SNMP Trap processing part 185 determines whether there is untreated VB 1406 (1708). If YES, the operation goes to step 1709. The SNMP Trap processing part 185 takes out the aid and the value from the VB 1406, and searches the MID DB 189 for the taken-out oid of the VB 1406 (1709). The SNMP Trap processing part 185 creates a corresponding XML tree from the search result and the value of the VB (1710), and adds the created XML tree to the HTTP response message (1711). This cycle is repeated until there is no untreated VB 1406. If there is no untreated VB 1406, the SNMP Trap processing part 185 sends the created HTTP response message to the network management device 103 (1712).

### Second Embodiment

Ina second embodiment, a function of acquiring the MIB using the first embodiment and using a Web service by making access to the Web service based on the information of MIB is provided.

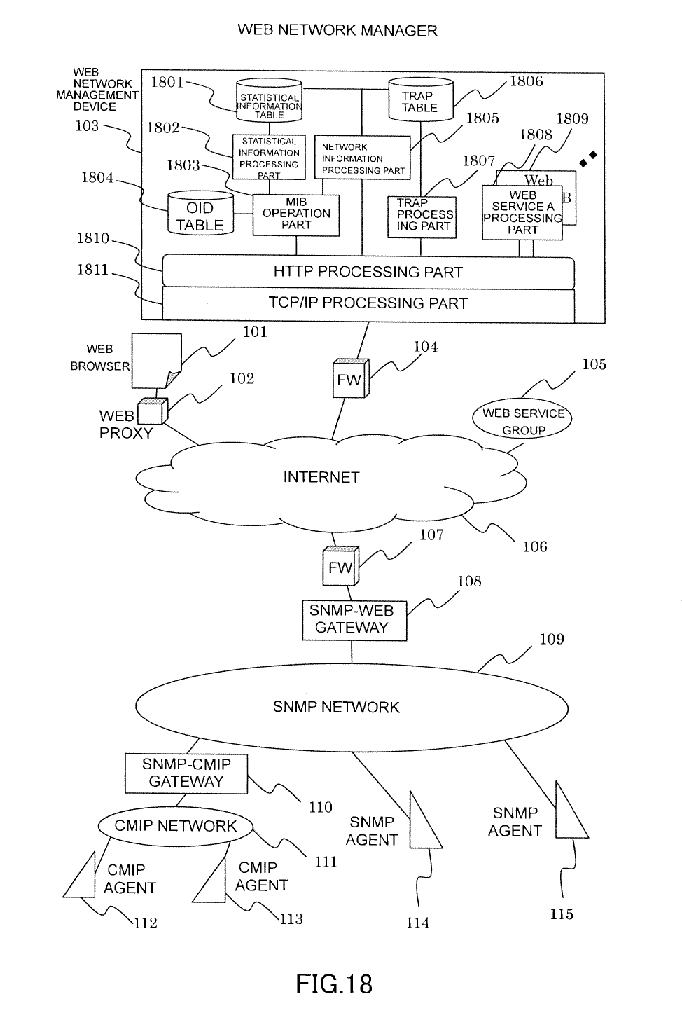

FIG. 18 is a block diagram showing one example of the network management device 103 according to the second embodiment.

The network management device 103 includes a TCP/IP processing part 1811 for performing the processing of a TCP/IP protocol, an HTTP processing part 1810 for performing the processing of an HTTP protocol, an OID table 1804 for holding the OID associated with the Object name, an MIB operation part 1803 for searching the OID table 1804 and adding an oid parameter to the HTTP request message, a statistical information table 1801 for holding the statistical information, a statistical information processing part 1802 for periodically acquiring the statistical information in the HTTP and updating the statistical information table, a Trap table 1806 for holding the Trap information, a Trap processing part 1807 for acquiring the Trap information and adding it to the Trap table, a network information processing part 1805 for acquiring the MIB, statistical information or Trap information in accordance with a request from the Web browser 101 to respond to the Web browser 101, and Web service processing parts 1808 and 1809 for processing each Web service.

The network management device 103 is connected via the FW 104 to the internet 106. The other components are the same as in FIG. 1.

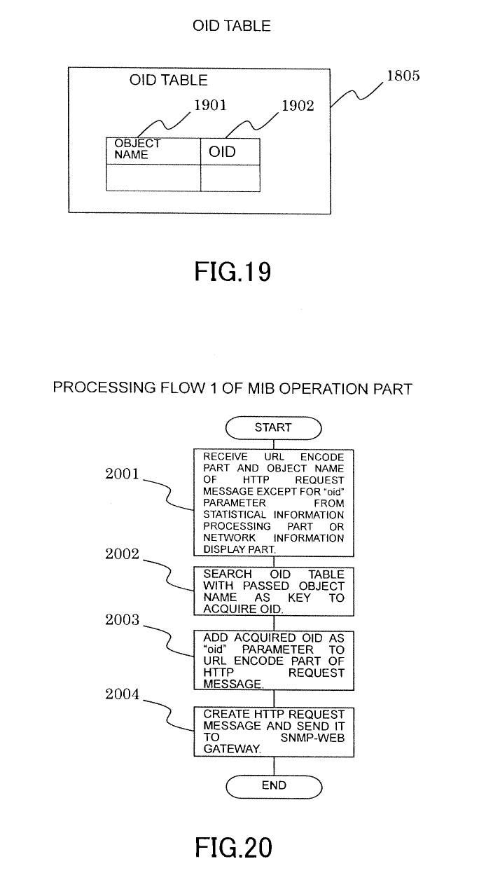

FIG. 19 is a table organization view of the OID table 1804.

The OID table 1804 has a pair of Object name 1901 and OID 1902 in the MIB. For example, the OID table is used to retrieve the corresponding OID from the Object name.

FIG. 20 is a flowchart showing a first operation of the MIB operation part 1803.

First of all, the MIP operation part 1803 receives the URL encode part and the Object name of the HTTP request message except for the oid parameter from the statistical information processing part 1802 or the network information processing part 1805 (2001).

The URL encode part received herein includes the host 401/501, the opr 402/502, or the value 504, for example, in accordance with the kind of the request. And the MIB operation part 1803 searches the OID table 1804 with the passed Object name as the key, and acquires the OID corresponding to the Object name (2002). The MIB operation part 1803 adds the acquired OID as the oid parameter 403/503 to the URL encode part of the HTTP request message received at step 2001 (2003). The MIB operation part 1803 creates the HTTP request message using the URL encode part, and sends it to the gateway device 108 (2004).

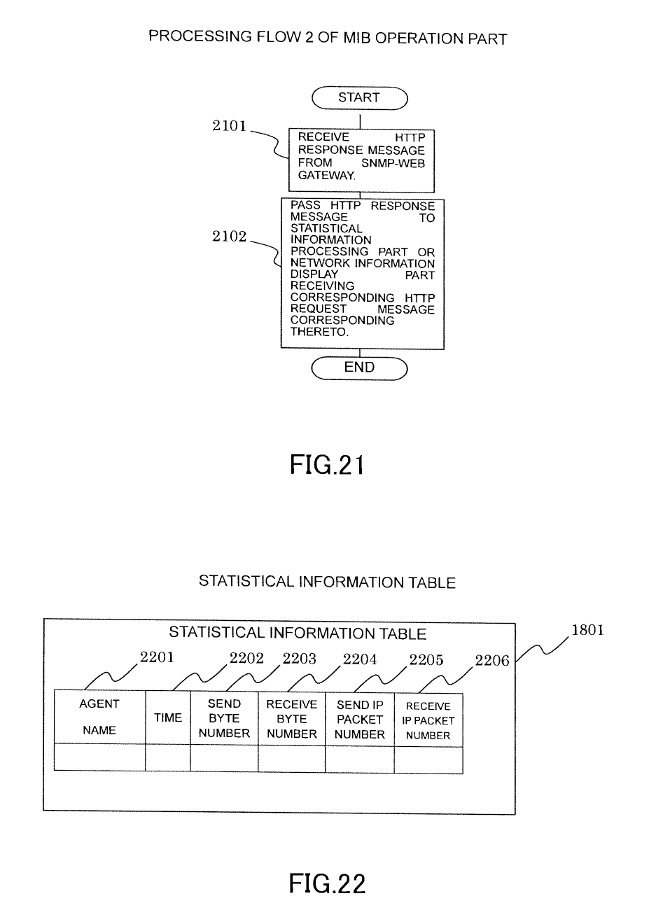

FIG. 21 is a flowchart showing a second operation of the MIB operation part 1803.

First of all, the MIB operation part 1803 receives an HTTP response message from the gateway device 108 (2101). For example, the same process of the first embodiment is performed for the HTTP request message sent at step 2004, and the HTTP response message sent from the gateway device 108 is received. The received HTTP response message is received in the same connection as the HTTP request message, whereby to which request the response is can be identified. The MIB operation part 1803 passes the HTTP response message to the statistical information processing part 1802 or the network information processing part 1805 receiving the corresponding HTTP request message at step 2001 (2102).

FIG. 22 is a table organization view of the statistical information table 1801.

The statistical information table 1801 includes an agent name 2201, a time 2202, a send Byte number 2203, a receive Byte number 2204, a send IP packet number 2205, and a receive IP packet number 2206. The agent name is an identifier such as the SNMP agent 114 or 115, for example, and may be pre-stored.

The other items than the agent name 2201 and the time 2202 are required to be statistical information that can be acquired as the MIB, though the other items are not shown in this drawing (e.g., send or receive UDP packet number or send or receive ICMP packet number).

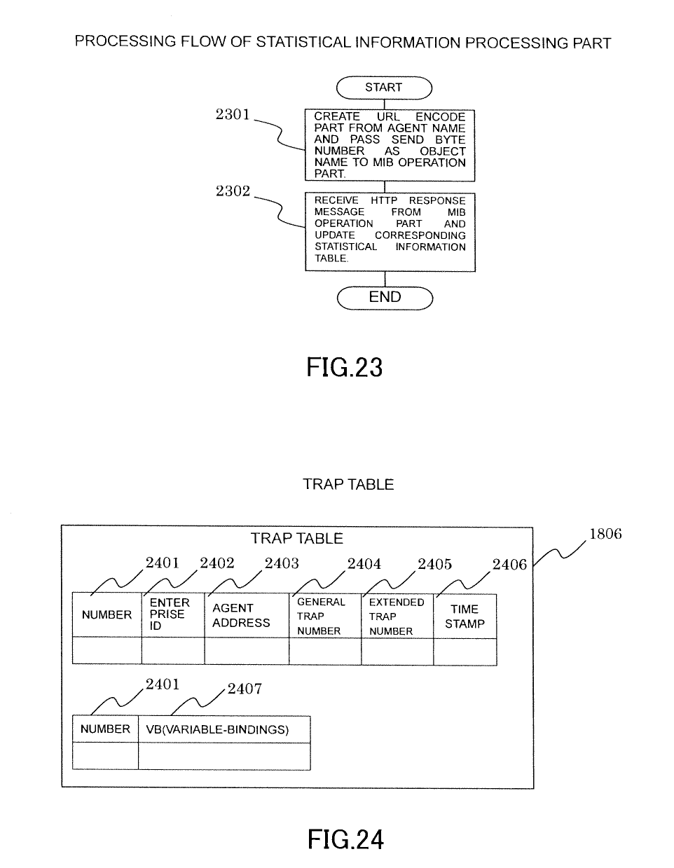

FIG. 23 is a flowchart showing the operation of the statistical information operation part 1802.

First of all, the statistical information processing part 1802 takes out the agent name 2201 of the statistical information table 1801, and creates a URL encode part. The request type 402 is set to opr=get, for example. And the statistical information processing part 1802 passes the URL encode part and the Object name, with the send Byte number as the Object name, to the MIB operation part 1803 (2301). The MIB operation part 1803 performs the above process, and passes an HTTP response message to the statistical information processing part 1802.

Next, the statistical information processing part 1802 receives the HTTP response message from the MIB operation part 1803. The HTTP response message received herein includes the information on the send Byte number designated in the Object name, for example. The statistical information processing part 1802 updates the corresponding item of the statistical information table 1801.

The above operation is performed by the number of items in the statistical information table 1801. For example, the information of each item in the statistical information table 1801 is acquired by changing the Object name successively, and the statistical information table 1801 is updated. The time 2202 may appropriately include the updated time or the time included in the HTTP response message.

FIG. 24 is a table organization view of the Trap table 1806.

The Trap table 1806 includes a number 2401 for uniquely identifying the Trap, an enterprise ID 2402, an agent address 2403, a general Trap number 2404, an extended Trap number 2405, a Time Stamp 2406 and a VB 2407. Since more than one VB 2407 may be possibly included in one Trap, the VB is stored in another table, associated with the number 2401, as shown in the drawing.

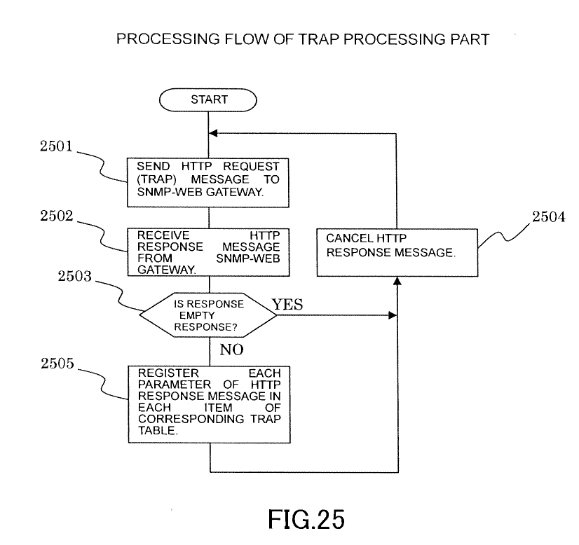

FIG. 25 is a flowchart showing the operation of the Trap operation part 1807.

First of all, the Trap processing part 1807 sends an HTTP request message of requesting the Trap information to the gateway device 108 (2501). The Trap processing part 1807 receives an HTTP response message from the gateway device 108 (2502). The Trap processing part 1807 determines whether or not the HTTP response message is empty (2503). If YES (in the case of empty), the Trap processing part 1807 cancels the HTTP response message (2504), and returns to the top. On the other hand, if NO (in the case of not empty), the Trap processing part 1807 registers each parameter (e.g., 1501 to 1505 of FIG. 15) of the received HTTP response message in each corresponding item of the Trap table 1806 (2505). The number 2401 of the Trap table 1806 may be appropriately assigned. Thereafter, the Trap processing part 1807 cancels the HTTP response message (2504), and returns to the top.

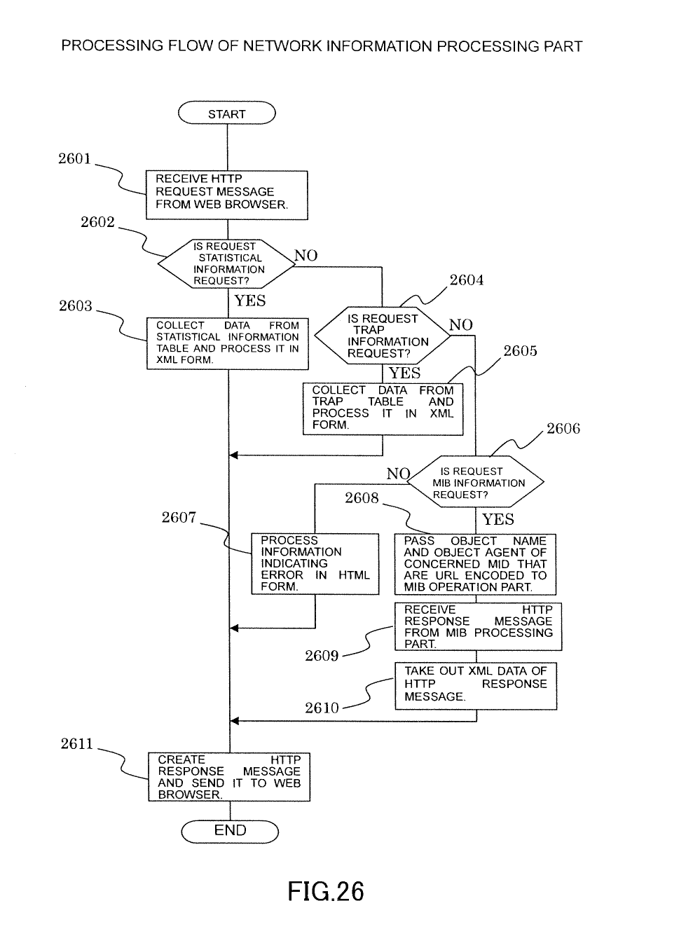

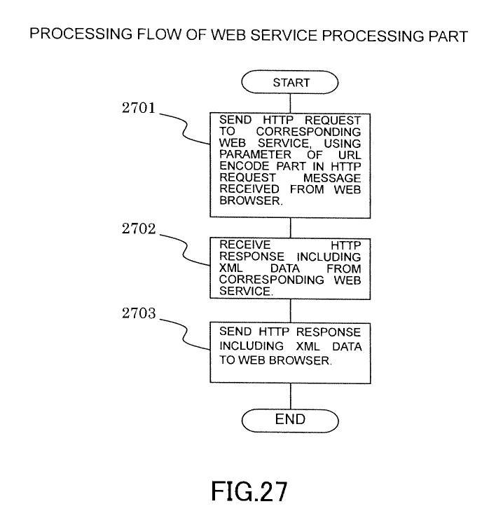

FIG. 26 is a flowchart showing the operation of the network information processing part 1805.

First of all, the network information processing part 1805 receives an HTTP request message from the Web browser 101 (2601). The HTTP request is sent with the user's operation as a moment, for example. The network information processing part 1805 determines whether the received HTTP request message indicates a request for statistical information (2602). If YES at step 2602, the network information processing part 1805 collects data from the statistical information table 1801, processes it in an XML form (2603), and creates an HTTP response message and sends it to the Web browser 101 (2611).

If NO at step 2602, the network information processing part 1805 determines whether the received HTTP request message indicates a request for Trap information (2604). If YES at step 2604, the network information processing part 1805 collects data from the Trap table 1806, processes it in the XML form (2605), and creates an HTTP response message and sends it to the Web browser 101 (2611).

If NO at step 2604, the network information processing part 1805 determines whether the received HTTP request message indicates a request for MIB information (2606). If NO at step 2606, the network information processing part 1805 processes the information indicating an error in the XML form (2607), and creates an HTTP response message and sends it to the Web browser 101 (2611). On the other hand, if YES at step 2606, the network information processing part 1805 passes the Object name and the object agent of the concerned MIB that are URL encoded to the MIB operation part 1803 (2608). The Object name and the object agent of the concerned MIB can be designated by the HTTP request message received at step 2601. The network information processing part 1805 receives an HTTP response message from the MIB operation part 1803 acquiring the information via the gateway device 108 at the above step (2609). And the network information processing part 1805 takes out XML data of the HTTP response message (2610), and creates an HTTP response message and sends it to the Web browser 101 (2611).

FIG. 27 is a flowchart showing the operation of the Web service processing parts 1808 and 1809.

First of all, the Web service processing parts 1808, 1809 send an HTTP request to the corresponding Web service, using the parameter in the URL encode part of the HTTP request message received from the Web browser 101 (2701). For example, the parameter of the URL encode part and the Web service are associated beforehand with each other, whereby the identification information or address information of the Web service can be pre-stored, associated with the parameter of the URL encode part. The Web service processing parts 1808, 1809 receive an HTTP response including XML data from the corresponding Web service (2702). And the Web service processing parts 1808, 1809 send the HTTP response including the XML data to the Web browser 101 (2703).

Though the required parameter and the XML data format are different depending on the Web service, it is required that the process is changed according to an Application Program Interface (API) as publicized.

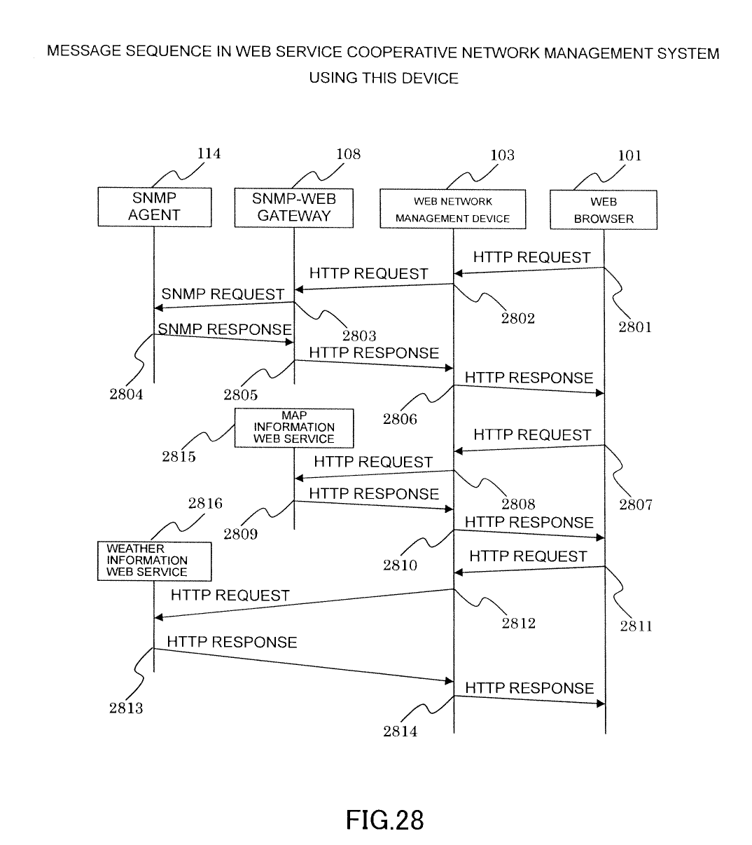

FIG. 28 is a chart showing an example of a message sequence in the network management system according to this embodiment.

For example, a message sequence of acquiring an address as the MIB information, and acquiring a peripheral map from the acquired address and a weather situation at the address from the Web service is exemplified.

First of all, an HTTP request message of requesting the MIB information of sys Location is sent from the Web browser 101 (2801). The network management device 103 receiving the HTTP request message transfers it to the gateway device 108 (2802). The gateway device 108 converts the received HTTP request message into an SNMP request, and sends it to the SNMP agent 114 of object (2803).

The SNMP agent 114 sends an SNMP response message including the sys Location information to the gateway device 108 (2804). The gateway device 108 converts the received SNMP response message into an HTTP response message, and sends it to the network management device 103 (2805). The network management device 103 transfers the received HTTP response message to the Web browser 101 (2806).

The Web browser 101 receiving the sys Location information sends an HTTP request message of requesting the map information based on that information to the network management device 103 (2807). The network management device 103 receives the message in the Web service processing part 1808 or 1809 corresponding to a map information service, and transfers it to a map information service (device such as a server providing the map information service) 2815 (2808). The map information service 2815 responds with the peripheral map information as an HTTP response based on the received information (2809). The Web service processing part 1808 or 1809 corresponding to the map information service of the network management device 103 transfers the received map information to the Web browser 101 (2810).

Also, the Web browser 101 receiving the sys Location information sends an HTTP request message of requesting the weather information to the network management device 103 based on that information (2811). The network management device 103 receives the message in the Web service processing part 1808 or 1809 corresponding to a weather information service, and transfers it to a weather information service (device such as a server providing the weather information service) 2816 (2812). The weather information service 2816 responds with the peripheral weather information as an HTTP response based on the received information (2813). The Web service processing part 1808 or 1809 corresponding to the weather information service of the network management device 103 transfers the received weather information to the Web browser 101 (2814).

The Web browser 101 properly displays the received sys Location information, map information and weather information on the display part.

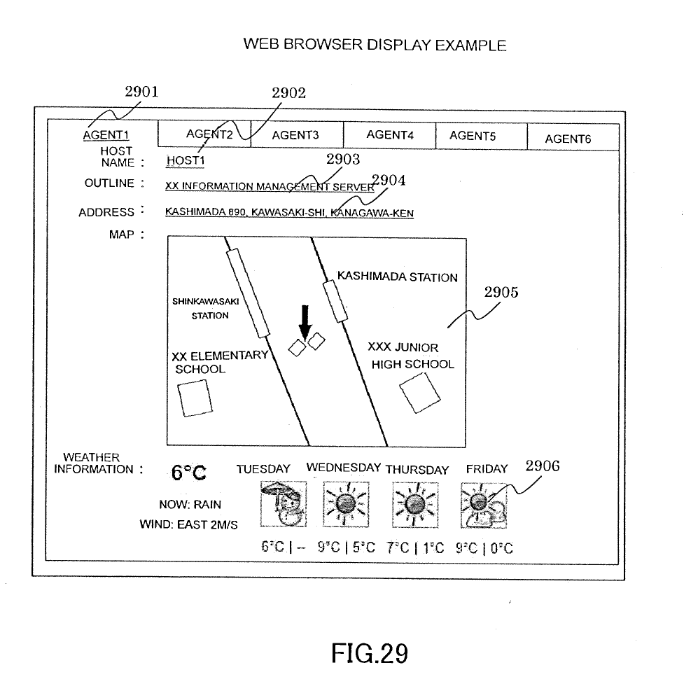

FIG. 29 is a view showing a Web browser display example in the network management system according to this embodiment.

In this drawing, an agent 1 2901, a host name 2902, outline information 2903, address 2904, map 2905, and weather information 2906 are displayed. In these items, the host name is acquired from the sys Name information of the MIB, the outline information is acquired from the sys Descr information of the MIB, the address is acquired from the sys Location information of the MIB, the map is acquired from the map information Web service based on the sys Location information, and the weather information is acquired from the weather information Web service based on the sys Location information.

The invention is applicable to the SNMP network using the Web technology, for example.

What is claimed is:

1. A network system comprising:
a gateway device for creating an SNMP request message from a first HTTP request message and sending it to an SNMP agent, and creating and sending a first HTTP response message from an SNMP response message to the SNMP request message; and
a network management device for communicating with the gateway device;
wherein the network management device includes:
an HTTP processing part for sending and receiving an HTTP request message and an HTTP response message corresponding thereto;
a network information processing part for receiving a second HTTP request message for requesting a desired Management Information Base (MIB) of the SNMP agent via the HTTP processing part from a Web browser; and
an MIB operation part for creating the first HTTP request message including an object identifier of the desired MIB and outputting it via the HTTP processing part to the gateway device;
wherein the network information processing part receives the first HTTP response message to the first HTTP request message from the gateway device, the first HTTP response message including the MIB of the SNMP agent, creates a second HTTP response message including the MIB and sends it via the HTTP processing part to the Web browser.

2. The network system according to claim 1, wherein
the network management device further comprises an object identifier table for holding an object name of the NIB and an object identifier that are associated, and
the MIB operation part acquires a desired object name of the MIB or the object identifier corresponding to a predetermined object name of the MIB, included in the second HTTP request message by referring to the object identifier table, and creates the first HTTP request message including acquired object identifier.

3. The network system according to claim 2, wherein
the network management device further comprises:
a statistical information table for holding the statistical information of the MIB, including one or more of send Byte number, receive Byte number, send IP packet number, and receive IP packet number of each SNMP agent; and
a statistical information processing part for periodically acquiring the statistical information of the SNMP agent via the MIB operation part and the gateway device, and updating the statistical information table,
wherein the MIB operation part
creates the first HTTP request message including the object identifier corresponding to the object name, with each element of the statistical information as the object name, to output it to the gateway device, and
receives the first HTTP response message to the first HTTP request message from the gateway device to output it to the statistical information processing part, the first HTTP response message including the statistical information of the SNMP agent, and
wherein the network information processing part acquires the statistical information of the SNMP agent from the statistical information table in accordance with the second HTTP request message for requesting the statistical information of the SNMP agent, creates the second HTTP response message including the statistical information, and sends it via the HTTP processing part to the Web browser.

4. A network system comprising:
a gateway device for storing a received SNMP Trap message; and
a network management device for communicating with the gateway device;
wherein the network management device includes:
an HTTP processing part for sending and receiving an HTTP request message and an HTTP response message corresponding thereto;
a Trap table for holding contents of the SNMP Trap message received from the gateway device;
a Trap processing part for creating a first HTTP request message for requesting the SNMP Trap message, sending it via the HTTP processing part to the gateway device, receiving a first HTTP response message including the contents of the SNMP Trap message from the gateway device via the HTTP processing part, and storing the contents of the SNMP Trap message in the Trap table; and
a network information processing part for receiving a second HTTP request message for requesting Trap information from the Web browser via the HTTP processing part, acquiring the contents of the SNMP Trap message from the Trap table, creating a second HTTP response message including the contents of the SNMP Trap message, and sending it via the HTTP processing part to the Web browser.

5. The network system according to claim 4, wherein
the network management device further comprises a Web service processing part for receiving a third HTTP request message for requesting the use of a Web service on the internet via the HTTP processing part from the Web browser, taking out an input parameter of the Web service from received third HTTP request message, accessing to the Web service via the HTTP processing part, creating a third HTTP response message including information received from the Web service, and sending it via the HTTP processing part to the Web browser.

6. The network system according to claim 5, wherein
the network management device comprises a plurality of the Web service processing parts each corresponding to each Web service for a plurality of Web services on the internet.

7. The network system according to claim 5, wherein
the third HTTP request message includes at least part of the MIB included in the second HTTP request message.

8. The network system according to claim 1, wherein
the gateway device comprises:
a second HTTP processing part for receiving the first HTTP request message from the network management device and sending the first HTTP response message to the network management device;
an SNMP processing part for sending the SNMP request message to the SNMP agent and receiving the SNMP response message from the SNMP agent;
a request processing part for creating the SNMP request message from the first HTTP request message received by the second HTTP processing part and outputting it to the SNMP processing part; and
a response processing part for creating the first HTTP response message from the SNMP response message received by the SNMP processing part and outputting it to the second HTTP processing part,
wherein the request processing part creates the SNMP request message by adding request type information included in received first HTTP request message and an object identifier for specifying information of object to the SNMP request message, and
wherein the response processing part creates the first HTTP response message including the object identifier and the value information, based on a pair of the object identifier and the value information indicating the information of the object that are included in the SNMP response message sent in response to the SNMP request message.

9. The network system according to claim 8, wherein
the first HTTP request message received from the network management device includes at least sending destination information indicating the SNMP agent, the request type information and the object identifier for specifying the information of object, and
the request processing part sets the request type information included in received first HTTP request message in a PDU type field of the SNMP request message, sets the object identifier included in the first HTTP request message in a VB field of the SNMP request message, and sends the SNMP request message via the SNMP processing part to the SNMP agent in accordance with the sending destination information.

10. The network system according to claim 9, wherein
the first HTTP request message further includes the value information indicating a setting value, and
the request processing part sets a pair of the object identifier and the value information, that are included in the first HTTP request message, in the VB field of the SNMP request message.

11. The network system according to claim 8, wherein
the SNMP response message received from the SNMP agent includes at least a pair of the object identifier and the value information, and
the response processing part creates an XML tree including the object identifier and the value information, based on the pair of the object identifier and the value information included in received SNMP response message, creates the first HTTP response message with the XML tree added, and sends the first HTTP response message via the HTTP processing part to the network management device.

12. The network system according to claim 4, wherein
the gateway device further comprises:
a second HTTP processing part for receiving the first HTTP request message from the network management device and sending the first HTTP response message to the network management device;
an SNMP processing part for sending an SNMP request message to an SNMP agent and receiving an SNMP response message from the SNMP agent;
an SNMP Trap queue for storing the SNMP Trap message received by the SNMP processing part; and
an SNMP Trap processing part for inputting received SNMP Trap message into the SNMP Trap queue.

13. The network system according to claim 12, wherein
the second HTTP processing part receives the first HTTP request message for requesting the SNMP Trap message, and
the SNMP Trap processing part, if the SNMP Trap message is stored in the SNMP Trap queue, takes out the SNMP Trap message, creates the first HTTP response message including the contents of the SNMP Trap message and sends it via the second HTTP processing part to the network management device.

14. The network system according to claim 12, wherein
the second HTTP processing part receives the first HTTP request message for requesting the SNMP Trap message, and waits for the SNMP Trap message to be stored in the SNMP Trap queue for a predetermined period of time, if the SNMP Trap message is not stored in the SNMP Trap queue, in which if the SNMP Trap message is not stored within the period of time, the second HTTP processing part creates an HTTP response message indicating that there is no SNMP Trap message and sends it via the first HTTP processing part to the network management device.

15. A network management device in a network system which comprises a gateway device for creating an SNMP request message from a first HTTP request message and sending it to an SNMP agent, and creating and sending a first HTTP response message from an SNMP response message to the SNMP request message and, the network management device for communicating with the gateway device, the network management device comprising:
an HTTP processing part for sending and receiving an HTTP request message and an HTTP response message corresponding thereto;
a network information processing part for receiving a second HTTP request message for requesting a desired Management Information Base (MIB) of the SNMP agent via the HTTP processing part from a Web browser; and
an NIB operation part for creating the first HTTP request message including an object identifier of the desired MIB and outputting it via the HTTP processing part to the gateway device;
wherein the network information processing part receives the first HTTP response message to the first HTTP request message from the gateway device, the first HTTP response message including the MIB of the SNMP agent, creates a second HTTP response message including the MIB and sends it via the HTTP processing part to the Web browser.

16. A gateway device comprising:
an HTTP processing part for receiving an HTTP request message from a network management device and sending an HTTP response message to the network management device;
an SNMP processing part for sending an SNMP request message to an SNMP agent and receiving an SNMP response message from the SNMP agent;
a request processing part for creating the SNMP request message from the HTTP request message received by the HTTP processing part and outputting it to the SNMP processing part; and
a response processing part for creating the HTTP response message from the SNMP response message received by the SNMP processing part and outputting it to the HTTP processing part,
wherein the request processing part creates the SNMP request message by adding request type information included in received HTTP request message and an object identifier for specifying information of object to the SNMP request message, and
wherein the response processing part creates the HTTP response message including the object identifier and value information, based on a pair of the object identifier and the value information indicating the information of the object that are included in the SNMP response message sent in response to the SNMP request message.

17. The network system according to claim 1, wherein
the network management device further comprises a Web service processing part for receiving a third HTTP request message for requesting the use of a Web service on the internet via the HTTP processing part from the Web browser, taking out an input parameter of the Web service from received third HTTP request message, accessing to the Web service via the HTTP processing part, creating a third HTTP response message including information received from the Web service, and sending it via the HTTP processing part to the Web browser.

18. The network system according to claim 17, wherein
the network management device comprises a plurality of the Web service processing parts each corresponding to each Web service for a plurality of Web services on the internet.

19. The network system according to claim 17, wherein
the third HTTP request message includes at least part of the MIB included in the second HTTP request message.
